(19) United States
(12) Patent Application Publication
(10) Pub. No.: US 2009/0031379 A1
(43) Pub. Date: Jan. 29, 2009

(54) Method and system for providing a broadcast program and associated web content

(75) Inventor: Kenneth Michel, Brightwaters, NY (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: Disney Enterprises, Inc.

(21) Appl. No.: 11/880,677

(22) Filed: Jul. 23, 2007

(51) Int. Cl. H04N 7/173

(52) U.S. Cl. 725/110

(57) ABSTRACT

There is provided a method for use by a processing device for providing a broadcast program and Web content associated with the broadcast program. According to one embodiment, the method includes selecting a broadcast channel and receiving a broadcast program on the broadcast channel. The broadcast program can be, for example, a movie or a television show. The method further includes determining a Web site associated with the broadcast channel. In one embodiment, the Web site can be a dynamic Web site hosted by a channel link server. The method further includes receiving Web content associated with the broadcast program from the Web site. In one embodiment, the Web content is synchronized with the broadcast program based on a program schedule. The method further includes providing the Web content and the broadcast program to an output display contemporaneously.

### BACKGROUND OF THE INVENTION

1. Field of the Invention

The present invention relates generally to techniques for distributing Web content. More particularly, the present invention relates to systems and techniques for providing a broadcast program and Web content associated with a broadcast program.

2. Background Art

Audio/video devices, such as televisions, can be used to receive and display broadcast programs that are provided by various program providers. For example, a broadcast program from a program provider can be transmitted on a predetermined broadcast channel using over-the-air, cable, or satellite broadcasting techniques known in the art. The broadcast program can be, for example, a movie or a television show. An audio/video device can be configured to receive the broadcast program and to display the broadcast program on an output display.

With the rapid growth of the World Wide Web and the increasing functionality of today's audio/video devices, it is becoming highly desirable to use audio/video devices to receive and display World Wide Web content (“Web content”), thereby allowing Web content publishers to reach new and larger audiences. In particular, by displaying Web content on typical audio/video devices, such as TV's, the Web content publishers can reach more users and audiences. Today, conventional audio/video devices, however, are limited to allowing conventional Web browsing, where the audio/video devices are merely used as monitors or display panels.

### SUMMARY OF THE INVENTION

There is provided methods and systems for providing a broadcast program and associated Web content, substantially as shown in and/or described in connection with at least one of the figures, as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 illustrates a diagram of a system for providing a broadcast program and associated Web content, in accordance with one embodiment of the invention; and

FIG. 2 illustrates a flowchart for performing a method for providing a broadcast program and associated Web content, in accordance with one embodiment of the invention.

### DETAILED DESCRIPTION OF THE INVENTION

Although the invention is described with respect to specific embodiments, the principles of the invention, as defined by the claims appended herein, can obviously be applied beyond the specifically described embodiments of the invention described herein. Moreover, in the description of the present invention, certain details have been left out in order to not obscure the inventive aspects of the invention. The details left out are within the knowledge of a person of ordinary skill in the art.

The drawings in the present application and their accompanying detailed description are directed to merely example embodiments of the invention. To maintain brevity, other embodiments of the invention which use the principles of the present invention are not specifically described in the present application and are not specifically illustrated by the present drawings. It should be borne in mind that, unless noted otherwise, like or corresponding elements among the figures may be indicated by like or corresponding reference numerals.

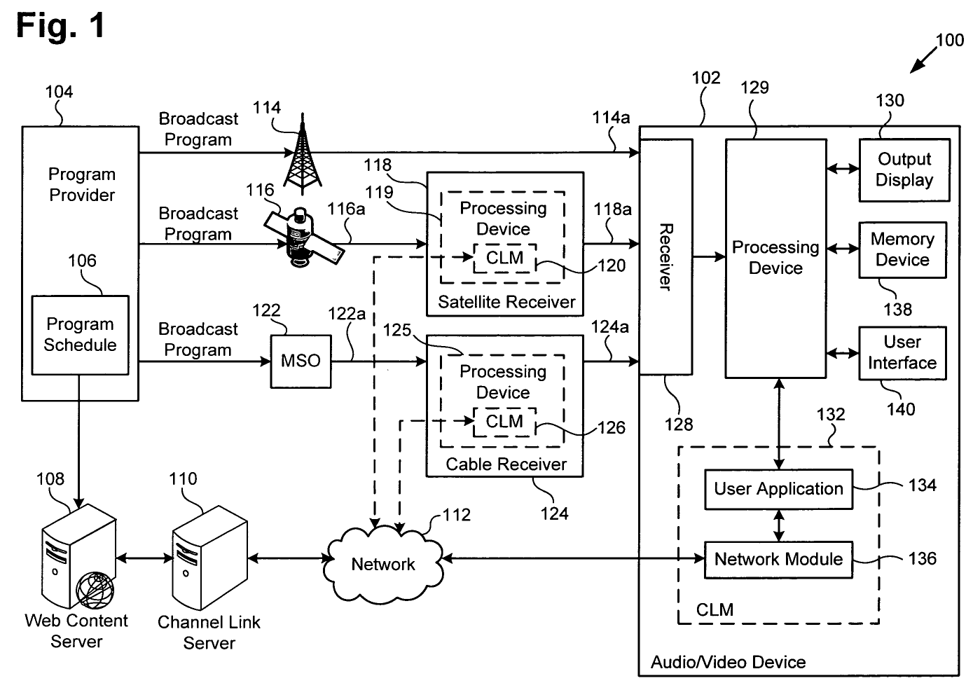

FIG. 1 illustrates a block diagram of system 100 for providing a broadcast program and associated Web content, in accordance with one embodiment of the invention. System 100 includes audio/video device 102, program provider 104, Web content server 108, channel link server 110, network 112, over-the-air broadcast tower 114, broadcast satellite 116, satellite receiver 118, multiple system operator (“MSO”) 122, and cable receiver 124.

As shown in FIG. 1, audio/video device 102 includes receiver 128, processing device 129, output display 130, channel link module (“CLM”) 132, memory device 138, and user interface 140. Audio/video device 102 can be, for example, any electronic device cable of receiving and displaying audio and video information, such as a digital television, a PDA or a personal computer. In the embodiment of FIG. 1, output display 130, receiver 128, memory device 138, user interface 140, and CLM 132 are all coupled to processing device 129. Processing device 129 can be, for example, a central processing unit (“CPU”) or a microcontroller. Output display 130 can be, for example, a liquid crystal display (“LCD”), a plasma display panel, or any other type of display. As shown in FIG. 1, CLM 132 includes user application 134 and network module 136, where user application 134 is coupled to network module 136. Network module 136 can be, for example, a wired or wireless Ethernet adapter, a Wi-Fi module, a cellular module, a cable modem, or a digital subscriber line (“DSL”) modem. As shown in FIG. 1, user application 134 is in communication with processing device 129.

As shown in FIG. 1, program provider 104 can provide a broadcast program to over-the-air (“OTA”) broadcast tower 114, broadcast satellite 116, cellular broadcast (not shown), and multiple system operator (“MSO”) 122 utilizing broadcasting techniques known in the art. The broadcast program can be, for example, a movie, a television show, a sporting event, a documentary, an animation, a music video, or an advertisement.

As shown in FIG. 1, OTA broadcast tower 114 can transmit the broadcast program using over-the-air broadcast signal 114a. OTA broadcast signal 114a can be transmitted, for example, on a broadcast channel, such as a television broadcast channel known in the art. As shown in FIG. 1, OTA broadcast signal 114a is received by audio/video device 102 in receiver 128. In one embodiment, receiver 128 can include an antenna and a channel tuner module, which are not shown in FIG. 1 for ease of illustration. In such an embodiment, the channel tuner module can be used to select the broadcast channel of OTA broadcast signal 114a, thereby allowing processing device 129 to receive the broadcast program on the broadcast channel. For example, processing device 129 can select the broadcast channel of OTA broadcast signal 114a by appropriately tuning the channel tuner module in receiver 128. In one embodiment, processing device 129 can select the broadcast channel in a manner described above in response to a command input by a user through user interface 140. User interface 140 can include, for example, one or more buttons that can be used for selecting a desired broadcast channel, and/or an infrared signal receiver for receiving infrared signals from a remote control device, such as a television remote control unit known in the art.

In one embodiment of the invention, the selected broadcast channel discussed above can be associated with a Web site or a Web page hosted by at least one channel link server, such as channel link server 110. Channel link server 110 can be, for example, a Web server. As shown in FIG. 1, channel link server 110 is in communication with network 112, which can be a publicly accessible network, such as the Internet. In one embodiment, the Web site associated with the selected broadcast channel can be a dynamic Web site. Accordingly, channel link server 110 can employ a server-side script configured to update the Web site with Web content associated with the broadcast program being transmitted on the selected broadcast channel.

In one embodiment, channel link server 110 can be configured to update the Web site associated with the broadcast channel based on a program schedule, such as program schedule 106, which is typically provided by a program provider. As shown in FIG. 1, program provider 104 can provide program schedule 106 to Web content server 108, which is in communication with channel link server 110. Web content server 108 can be, for example, a Web server configured to store and distribute various Web content, such as text, images, sounds, videos, and music. In one embodiment, program schedule 106 can include a list of the titles and the corresponding viewing times (also referred to in the art as “air-times”) of the various broadcast programs that are scheduled to be transmitted on the broadcast channel used by program provider 104. Thus, program schedule 106 can be used by channel link server 110 to determine the particular broadcast program being transmitted on the broadcast channel at any given time.

In one embodiment, Web content server 108 in FIG. 1 can be configured to store Web content associated with the various broadcast programs included in program schedule 106. For example, program provider 104 can be a television network, such as the American Broadcasting Company (“ABC”), and program schedule 106 might include various broadcast programs and their corresponding viewing times, such as a sporting event scheduled to begin at 6:30 p.m. and a movie scheduled to begin at 9:00 p.m. Accordingly, in one embodiment, Web content server 108 can be configured to store Web content associated with the sporting event, such as news about the players participating in the sporting event, statistics of the teams and players participating in the sporting event, and advertisements related to the sporting event. Web content server 108 can be further configured to store Web content associated with the abovementioned movie, such as biographical information about the actors in the movie, exclusive images of the actors, and the titles and corresponding viewing times of other movies that might be of interest to viewers. Even more, Web content can include data, sound, text or video that is streamed synchronously with the associated broadcast program. In other words, Web content can be synchronized frame-by-frame or segment-by-segment with respect to the broadcast program and be provided to the display device.

As previously discussed with respect to one embodiment of the invention, processing device 129 can be configured to receive the broadcast program provided by program provider 104 by selecting the appropriate broadcast channel. In one embodiment, user application 134 in CLM 132 can configure processing device 129 to detect the selected broadcast channel and to determine a Web site associated with the selected broadcast channel. In one embodiment, the domain name or the Internet Protocol (“IP”) address of the Web site associated with the broadcast channel can be stored in memory device 138 of audio/video device 102. Memory device 138 can be, for example, a non-volatile memory device, such as a hard disk. Accordingly, user application 134 can configure processing device 129 to determine the Web site associated with the selected broadcast channel by accessing memory device 138 and retrieving the domain name or the IP address associated with the selected broadcast channel. Once processing device 129 has determined the Web site associated with the selected broadcast channel, user application 134 can configure processing device 129 to access the Web site through network module 136. As shown in FIG. 1, network module 136 is in communication with network 112. Thereafter, user application 134 can configure processing device 129 to receive Web content associated with the broadcast program from the Web site. For example, if the broadcast program being transmitted on the selected broadcast channel is the sporting event described above, the Web content can be associated with the sporting event and can include news regarding the players participating in the sporting event, statistics of the teams and players participating in the sporting event, and advertisements related to the sporting event.

User application 134 can then configure processing device 129 to provide the Web content and the broadcast program to output display 130. In one embodiment, the Web content can be displayed on output display 130 contemporaneously with the broadcast program. For example, the Web content can be formatted by user application 134 to wrap around an area in which the broadcast program is being displayed. As another example, a split screen technique can be used to contemporaneously display the broadcast program and associated Web content. In one embodiment, user application 134 can allow a user to interact with the Web content displayed on output display 130, thereby allowing for an interactive Web experience. For example, if the Web content being displayed on output display 130 includes a link to a different Web site, the user may utilize user interface 140 to select the link to display the different Website while the broadcast program is being displayed.

As shown in FIG. 1, and as discussed above, program provider 104 can also provide the broadcast program to broadcast satellite 116. Broadcast satellite 116 can then transmit the broadcast program on a broadcast channel in satellite signal 116a using techniques known in the art. As shown in FIG. 1, satellite signal 116a can be received by satellite receiver 118, which can be for example, a set-top box. As also shown in FIG. 1, satellite receiver 118 includes processing device 119, which includes channel link module (“CLM”) 120. Processing device 119 can be, for example, a data processing circuit. In one embodiment, CLM 120 includes a user application and a network module (not shown in FIG. 1) similar to user application 134 and network module 136 of CLM 132. As further shown in FIG. 1, CLM 120 is in communication with network 112.

Processing device 119 in satellite receiver 118 can be configured to receive the broadcast program provided by program provider 104 by selecting the appropriate broadcast channel in satellite signal 116a. In one embodiment, and similar to processing device 129, processing device 119 can be configured to detect the selected broadcast channel and to determine a Web site associated with the selected broadcast channel. In one embodiment, processing device 119 can be configured to determine a Web site associated with the selected broadcast channel by accessing a memory device in satellite receiver 118 (not shown in FIG. 1) and retrieving the domain name or the IP address associated with the selected broadcast channel. Thereafter, processing device 119 can be configured to access the Web site to receive Web content associated with the broadcast program. Processing device 119 can then provide the broadcast program and associated Web content to receiver 128 via signal path 118a, which can then be contemporaneously displayed on output display 130. Signal path 118a can be implemented, for example, by a coaxial cable. In one embodiment, CLM 132 of audio/video device 102 is disabled when CLM 120 is being used.

As shown in FIG. 1, and as discussed above, program provider 104 can also provide the broadcast program to MSO 122. MSO 122 can then transmit the broadcast program on a broadcast channel in MSO signal 122a using techniques known in the art. MSO signal 122a can be received by cable receiver 124, which can be for example, a set-top box. As also shown in FIG. 1, cable receiver 124 includes processing device 125, which includes channel link module (“CLM”) 126. Processing device 125 can be, for example, a data processing circuit. In one embodiment, CLM 126 includes a user application and a network module (not shown in FIG. 1) similar to user application 134 and network module 136 of CLM 132. As further shown in FIG. 1, CLM 126 is in communication with network 112.

Processing device 125 in cable receiver 124 can be configured to receive the broadcast program provided by program provider 104 by selecting the appropriate broadcast channel in MSO signal 122a. In one embodiment, and similar to processing device 129, processing device 125 can be configured to detect the selected broadcast channel and to determine a Web site associated with the selected broadcast channel. In one embodiment, processing device 125 can be configured to determine a Web site associated with the selected broadcast channel by accessing a memory device in cable receiver 124 (not shown in FIG. 1) and retrieving the domain name or the IP address associated with the selected broadcast channel. Thereafter, processing device 125 can be configured to access the Web site to receive Web content associated with the broadcast program. Processing device 125 can then provide the broadcast program and associated Web content to receiver 128 via signal path 124a, which can then be contemporaneously displayed on output display 130. Signal path 124a can be implemented, for example, by a coaxial cable. In one embodiment, CLM 132 of audio/video device 102 is disabled when CLM 126 is being used.

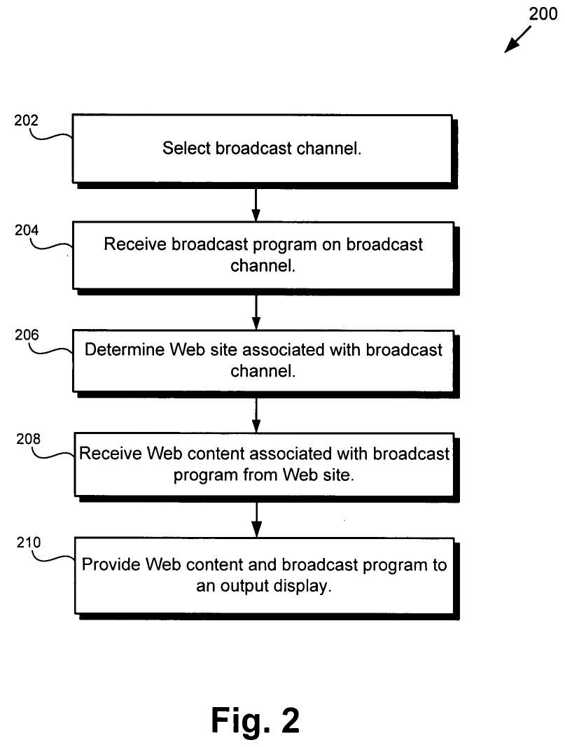

FIG. 2 illustrates flowchart 200 for performing an example method for providing a broadcast program and associated Web content, in accordance with one embodiment of the present invention. With reference to the embodiment shown in FIG. 1 and as shown in FIG. 2, at step 202 of flowchart 200, a broadcast channel is selected. At step 204, a broadcast program on the broadcast channel is received. At step 206, a Web site associated with the broadcast channel is determined. Then, at step 208, Web content associated with the broadcast program is received from the Web site. At step 210, the Web content and the broadcast program are provided to an output display.

Thus, the present invention advantageously associates a broadcast channel with a Web site, where the Web site can be configured to provide Web content associated with a broadcast program being transmitted on the broadcast channel. Therefore, it can be appreciated that the invention can be used with a number of various broadcast channels, such that each broadcast channel is associated with a particular Web site. For example, a first broadcast channel used by the Entertainment and Sports Programming Network (“ESPN”) can be associated with a first Web site and a second broadcast channel used by the American Broadcasting Company (“ABC”) can be associated with a second Web site. Accordingly, if a user viewing a broadcast program on the first broadcast channel selects the second broadcast channel, selection of the second broadcast channel can be detected and Web content from the second Web site can be provided to the display device. Since the channel link server of the invention can update a respective Web site with Web content based on a program schedule, the provided Web content can be advantageously synchronized with the broadcast programs transmitted on each broadcast channel.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. For example, it is contemplated that the circuitry disclosed herein can be implemented in software, or vice versa. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method for use by a processing device for providing a broadcast program and Web content associated with said broadcast program for display, said method comprising:
selecting a broadcast channel;
receiving said broadcast program on said broadcast channel;
determining a Web site associated with said broadcast channel;
receiving said Web content associated with said broadcast program from said Web site; and
providing said Web content and said broadcast program to an output display contemporaneously.

2. The method of claim 1 wherein said Web content is synchronized with said broadcast program based on a program schedule.

3. The method of claim 1 wherein said processing device includes a channel link module, said channel link module including a network module and a user application.

4. The method of claim 3 wherein said network module is one of an Ethernet adapter, a Wi-Fi module, a cable modem, or a digital subscriber line (“DSL”) modem.

5. The method of claim 1 wherein said Web site is hosted by at least one channel link server.

6. The method of claim 1 wherein said Web content is provided to said Web site from a Web content server.

7. The method of claim 1 wherein said Web content is one of a text, an image, a sound, a video, or music.

8. The method of claim 1 wherein said processing device is situated in one of a digital television, a satellite receiver, or a cable receiver.

9. The method of claim 1 wherein said broadcast program is one of a movie, a television show, a sporting event, a documentary, an animation, a music video, or an advertisement.

10. The method of claim 1 wherein said broadcast channel is one of an over-the-air (“OTA”) broadcast channel, a satellite broadcast channel, or a cable broadcast channel.

11. A system for providing a broadcast program and Web content associated with said broadcast program for display, said system comprising:
a processing device configured to select a broadcast channel to receive said broadcast program, said processing device being configured to determine a Web site associated with said broadcast channel;
at least one channel link server, said at least one channel link server being configured to host said Web site, said channel link server being configured to update said Web site with said Web content associated with said broadcast program;
wherein said processing device receives said Web content associated with said broadcast program and provides said broadcast program and said Web content to an output display contemporaneously.

12. The system of claim 11 wherein said Web content is synchronized with said broadcast program based on a program schedule.

13. The system of claim 11 wherein said processing device includes a channel link module, said channel link module including a network module and a user application.

14. The system of claim 13 wherein said network module is one of an Ethernet adapter, a Wi-Fi module, a cable modem, or a digital subscriber line (“DSL”) modem.

15. The system of claim 11 further comprising a Web content server, wherein said Web site is configured to receive said Web content from said Web content server.

16. The system of claim 11 wherein said at least one channel link server is coupled to said processing device through a network.

17. The system of claim 11 wherein said Web content is one of a text, an image, a sound, a video, or music.

18. The system of claim 11 wherein said processing device is situated in one of a digital television, a satellite receiver, or a cable receiver.

19. The system of claim 11 wherein said Web site is a dynamic Web site.

20. The system of claim 11 wherein said broadcast program is one of a movie, a television show, a sporting event, a documentary, an animation, a music video, or an advertisement.
